(19) United States
(12) Patent Application Publication
(10) Pub. No.: US 2026/0203205 A1
(43) Pub. Date: Jul. 16, 2026

(54) General Purpose Apparatus, Method and Memory Model for Real-Time Contextual Analysis and Proposition Generation

(71) Applicant: Terry Lynn Dorsey, HANOVER, PA (US)

(72) Inventor: Terry Lynn Dorsey, HANOVER, PA (US)

(73) Assignee: MindMosaix, LLC, HANOVER, PA (US)

(21) Appl. No.: 19/024,376

(22) Filed: Jan. 16, 2025

(51) Int. Cl. G06F 12/02

(52) U.S. Cl. CPC G06F 12/0223

(57) ABSTRACT

An apparatus and methodology are disclosed for analyzing contextual data in real time to generate propositions, determine concept similarity, and identify surprising concepts within minutes of new information introduction. The invention incorporates a Memory Model inspired by human episodic memory, addressing limitations of large language models (LLMs) such as explainability, adaptability, and cost-effectiveness. This Memory Model dynamically stores and retrieves contextual information, enabling inference generation and rapid decision-making. Unlike conventional models, memories are stored based on their gist rather than syntax, ensuring scalability and adaptability. Additionally, contexts are treated as cues, facilitating precise and efficient retrieval of relevant information. Applications span industries such as healthcare, finance, and customer service, demonstrating the invention's versatility.

### CROSS-REFERENCE TO RELATED APPLICATIONS

This application claims the benefit of U.S. Provisional Application No. 63/623,242, filed on Jan. 20, 2024, entitled “General Purpose Apparatus, Method and Memory Model for Real-Time Contextual Analysis and Proposition Generation”, which is hereby incorporated by reference in its entirety.

### BACKGROUND OF THE INVENTION

Artificial Intelligence (AI) research has increasingly focused on natural language processing (NLP) using deep learning and large language models (LLMs). While LLMs excel in tasks like text summarization, classification, and question-answering, they face critical limitations. Their reliance on extensive computational resources and vast datasets makes them cost-prohibitive for many applications. Additionally, their static training processes impede their ability to adapt quickly to new information, often resulting in outputs that lack transparency and explainability. This can lead to issues such as hallucinations or challenges in tracing the source of information.

Conventional systems often rely on supervised learning approaches, which require large volumes of labeled data and extensive pretraining. While effective for static and well-defined tasks, such systems face challenges in dynamic, real-time environments where labeled data may be unavailable or impractical to obtain. In contrast, the Dynamic Gist-Based Memory Model (DGMM) operates in an unsupervised manner, leveraging graph-based algorithms to analyze and process data directly from the Memory Model. This eliminates the need for pretraining and allows the system to adapt dynamically to evolving contexts, enabling more flexible and scalable applications.

Existing systems often employ static models with fixed weights, which do not support real-time contextual analysis or dynamic adaptation. Consequently, they struggle to manage environments requiring rapid proposition generation or understanding of complex, evolving relationships. Moreover, traditional systems and LLMs have difficulty filtering and processing real-time data dynamically, limiting their application in scenarios where contexts shift rapidly. These shortcomings underscore the need for a novel approach.

Conventional knowledge graphs, though powerful, exhibit additional limitations that exacerbate these challenges. They typically lack temporal awareness, making it difficult to associate time with concepts or relationships and thereby limiting their ability to reflect historical changes or evolving contexts. Source representation is often absent, which hinders the ability to trace data provenance and verify credibility. Furthermore, traditional knowledge graphs focus heavily on action-oriented relationships, resulting in overly complex graphs with an overwhelming number of connections. They also fail to capture the “idea” or “gist” behind concepts, which reduces their capability to handle abstract or contextual queries.

The proposed invention addresses these challenges by simulating human episodic memory. It introduces a Memory Model that supports dynamic collection, persistence, retrieval, and analysis of concepts tailored to specific contexts. Unlike conventional methods, this invention stores memories based on their gist—not syntax—to optimize retrieval and minimize redundancy. Contexts act as cues, guiding precise selection of relevant information for analysis and decision-making. By integrating these features, the invention enables real-time proposition generation, inference creation, and identification of surprising concepts. Additionally, it resolves the limitations of knowledge graphs by explicitly tying time and source information to concepts, reducing graph complexity through fixed relationships, and focusing on abstract representations rather than action-centric mappings. These innovations offer solutions to the challenges of retraining, transparency, and computational inefficiency faced by traditional LLMs and knowledge graph implementations.

### SUMMARY OF THE INVENTION

The invention introduces a novel Memory Model referred to as the Dynamic Gist-Based Memory Model (DGMM) and system designed to address key limitations of traditional knowledge graphs and large language models (LLMs). By simulating human episodic memory, this invention enables real-time analysis, retrieval, and generation of contextual data. Concepts are explicitly tied to both time and their source, allowing for nuanced, context-aware retrieval and analysis. This integration supports tracing data provenance, validating credibility, and contextualizing information based on temporal or origin-specific attributes.

A key feature of the invention is a dynamic gist-based Memory Model, and the use of algorithms applied to selections of the Memory Model based on context cues. These context cues dynamically filter and prioritize subsets of memory, enabling the system to process only the most relevant data instead of the entirety of memory. This selective approach not only optimizes computational efficiency but also allows the system to operate in real time, as smaller, targeted subgraphs are analyzed. This contextual focus ensures that results are highly relevant to the task at hand, whether it involves concept similarity evaluation, proposition generation, or identifying surprising concepts.

This method of processing subsets of memory lays the foundation for implementing security protocols by isolating and protecting specific data based on its context. Additionally, it supports the ability to understand and identify different perspectives within the data, providing insights into potential biases. By analyzing memory through diverse contextual lenses, the system facilitates transparency and enables more informed decision-making processes.

The concept-centric structure enhances the invention by managing the reintroduction of concepts and reducing graph complexity. Unlike traditional knowledge graphs that focus on action-oriented mappings (where relationship names or types represent actions), this model anchors relationships directly to concepts. This design simplifies navigation and data interpretation, emphasizing abstract representations and providing a versatile framework for analyzing and managing knowledge.

Dynamic contexts act as cues, enabling precise and efficient retrieval of relevant data. This feature allows the system to dynamically filter and prioritize information, even in large datasets and graphs. Context cues help the system retrieve targeted subsets of information based on specific interactions, time ranges, or source criteria.

The invention employs gist-based memory storage, retaining information based on its essence rather than syntax. This method minimizes redundancy building high connectivity between concepts and elements, uncovering implicit relationships that traditional systems might overlook. By focusing on the “gist” of concepts, the model optimizes memory efficiency and relevance.

Real-time processing capabilities enable the system to adapt instantly to new information. The model dynamically updates relationships and nodes, ensuring it remains current and responsive to evolving contexts. This real-time adaptability makes the system highly suitable for dynamic and rapidly changing applications.

The invention supports critical tasks such as concept similarity evaluation, proposition generation, and surprising concept identification. Concept similarity evaluation uses vector embeddings and similarity algorithms to analyze and identify relationships between concepts, enabling nuanced contextual analysis. Proposition generation synthesizes related concepts, aiding in decision-making, hypothesis generation, and strategic planning. Surprising concept identification employs clustering algorithms to detect novel or unexpected patterns in data, providing actionable insights for innovation and adaptability.

By integrating these features, the invention enhances the usability, scalability, and explainability of knowledge systems. It resolves computational inefficiencies, lack of transparency, and the static nature of traditional models, offering a transformative framework for real-time contextual language processing. The invention uniquely integrates temporal, source, and abstract representations, positioning it as a groundbreaking approach to contextual knowledge management. The key features and innovations include time and source integration, concept-centric structure, predefined relationships, dynamic contexts as cues, gist-based memory, real-time processing, concept similarity evaluation, surprising concept identification, and proposition generation. To facilitate understanding of the invention, the table of terms and definitions is included below.

TABLE 1
Terms and Definitions

| Term | Definition |
|---|---|
| Dynamic Gist-Based | A graph-based model designed to store the contextual essence |
| Memory Model | or “gist” of concepts. |
| Concept | A unit of information represented in the DGMM, including |
| | subject, object, action, and metadata. |
| Contextual Cues | Dynamic indicators or triggers used to filter and prioritize stored |
| | concepts (e.g., time, source). |
| Graph-Based | A data structure organizing concepts, components, and |
| Representation | relationships using nodes and edges. |
| Concept Node | A central element in the graph-based representation |
| | encapsulating a concept and its attributes. |
| Element Node | A graph node representing a component of a concept. |
| Subject Element Node | A graph node representing the primary entity or focus of a |
| | concept and is identified by the HAS_SUBJECT relationship with |
| | the concept node. |
| Object Element Node | A graph node representing the target or receiver of the action in |
| | a concept and is identified by the HAS_OBJECT relationship with |
| | the concept node. |
| Action Element Node | A graph node representing the verb or relationship between the |
| | subject and object and is identified by the HAS_ACTION |
| | relationship with the concept node. |
| Modifier Element Node | A graph node adding descriptive detail to subjects, objects, or |
| | actions (e.g., adjectives, adverbs) and is identify via the |
| | MODIFY_SUBJECT, MODIFY_OBJECT, MODIFY_ACTION |
| | relationship with the concept node. |
| Embedding Vector | A numerical representation of a concept or its elements to |
| | capture semantic relationships. |
| Similarity Algorithm | A method for evaluating alignment or closeness between |
| | concepts using embedding vectors. |
| Proposition Generation | The process of synthesizing new statements or hypotheses from |
| | related concepts. |
| Surprising Concept | A concept identified as unexpected or novel based on deviations |
| | from established patterns. |
| Temporal Attribute | Metadata specifying when a concept or interaction occurred or |
| | was acquired. |
| Source Node | A graph node representing the origin of a concept (e.g., person, |
| | document, database). |
| Interaction Node | A node representing a session or grouping of related concepts |
| | linked by common context. |
| Contextual Importance | An algorithm ranking concepts based on relevance to a specific |
| Algorithm | context. |
| Dynamic Retrieval | The real-time process of selecting and retrieving relevant |
| | concepts based on contextual cues. |
| Clustering Algorithm | A method for grouping semantically similar concepts or |
| | identifying patterns in the DGMM. |
| Real-Time Processing | The system's ability to adapt and process new information |
| | instantaneously. |
| Temporal Node | A graph node representing time-related data, such as |
| | timestamps for concept acquisition. |
| Scalability | The capacity to handle increasing volumes of data, interactions, |
| | or concepts without degradation. |

### BRIEF DESCRIPTION OF DRAWINGS

The accompanying drawings provide visual representations of the invention, illustrating its structural and functional aspects. These diagrams are intended to facilitate understanding of the invention by depicting the DGMM, data flow, context filtering mechanisms, and key processes such as concept similarity evaluation, proposition generation, and surprising concept identification. Each figure highlights specific features and relationships within the system, emphasizing how the invention integrates time, source, and abstract representations to enable real-time contextual memory management. The drawings complement the detailed description, providing clarity and insight into the operation and applications of the invention.

FIG. 1: Depicts the novel structure of the DGMM, illustrating relationships between core nodes, including concepts, sources, elements, interactions, and time. This figure highlights the model's ability to organize and link data for dynamic reasoning and contextual understanding.

FIG. 2: Provides an example of the DGMM applied to specific concepts, showing how source, subject, object, and their modifiers are connected within the DGMM, along with associated interactions and time elements.

FIG. 3: Illustrates the data flow for concept ingestion, detailing how input data flows from the Collection Apparatus into the Memory Management Subsystem for processing, storage, and contextual alignment. This figure highlights the modularity of the ingestion process and the integration of the DGMM.

FIG. 4: illustrates an embodiment of the memory management subsystem, showing the flow of data from the External Apparatus (401) to the Memory Manager Interface (402), which facilitates interactions with the Memory Recall Manager (403) and Memory Storage (404). This architecture demonstrates how the system ingests, stores, and retrieves data efficiently, ensuring scalability and dynamic memory management.

FIG. 5: Highlights the Thought Simulation Subsystem, which consists of the Thought Manager Interface (502) and the Thought Manager (503). The subsystem processes input from the Collection Apparatus (501) and interacts with the Memory Management Subsystem (504) to retrieve and analyze memory constructs. The Thought Manager Interface (502) serves as the communication gateway, while the Thought Manager (503) simulates reasoning and generates insights based on stored memory. This subsystem demonstrates the invention's ability to simulate thought dynamically by leveraging memory data.

FIG. 6: Illustrates the process for analyzing context within the DGMM, showcasing how embedding vectors, similarity algorithms, and importance metrics work together to produce ranked outputs relevant to a given context.

FIG. 7: Highlights the output of the similarity algorithm, showing the central node and the strongest semantically related concepts identified through the DGMM. This visualization demonstrates the system's capability to cluster and analyze concept relationships.

FIG. 8: illustrates the process within the Thought Simulation Subsystem for determining surprising concepts. Input from the Collection Apparatus (501) is processed by the Thought Manager (503), which retrieves relevant memory constructs from the Memory Management Subsystem (504) via the Thought Manager Interface (502). By analyzing the retrieved constructs against expected patterns, the system identifies concepts that deviate from established norms, marking them as surprising for further reasoning or adjustment.

FIG. 9: Shows the detection of surprising concepts within the DGMM over time. It illustrates how the system identifies and reduces “surprise” (deviation from expected patterns) as it iteratively refines and aligns new information.

FIG. 10: Depicts a process for generating propositions and questions using the DGMM. The process begins with input data (1001-1004), where concepts and elements are analyzed for similarity (1005). Propositional concepts are then generated, stored with the system as the source (1006), and a configured maximum number of propositions and questions are returned (1007). This process ensures the dynamic creation of contextually relevant outputs based on semantic alignment within the DGMM.

FIG. 11: Depicts the algorithm for proposition generation within the DGMM, detailing the step-by-step process of analyzing root concepts, related elements, and modifiers to dynamically create meaningful propositions.

FIG. 12: Provides an example of the proposition generation algorithm in action, demonstrating how the root concept (“tree grows”) connects directly to related concepts and indirectly to higher-order categories (e.g., “plant”) through shared semantic relationships.

FIG. 13: Illustrates the system architecture for memory management and thought simulation, integrating the Collection Apparatus, Memory Management Subsystem, and Thought Simulation Subsystem. The figure emphasizes modularity, scalability, and efficient data flow.

FIG. 14: Depicts a distributed system architecture, showcasing multiple instances of memory management and thought simulation components. It emphasizes the centrality of the DGMM and highlights scalability for large-scale data processing and reasoning.

### DETAILED DESCRIPTION OF THE INVENTION

The present invention provides an innovative system for the collection, generation, organization, and management of structured thoughts through a modular and scalable architecture. By leveraging a graph-based Memory Model, the invention efficiently transforms raw input into enriched thoughts that can be stored, retrieved, and utilized across various applications. This invention is designed to address the challenges of handling unstructured data by breaking it into discrete components, synthesizing it into meaningful constructs, and persisting it for real-time or future use.

The detailed description below elaborates on the invention's core components, including the Collection Apparatus, Thought Manager Interface, Thought Manager, and Memory Management Subsystem, and their roles in ensuring seamless data flow and processing. Each component is designed to work in harmony, forming a robust framework that highlights the invention's flexibility, efficiency, and adaptability. By enabling the structured generation and management of thoughts, this invention presents a novel approach to thought processing and memory organization, offering wide-ranging applications across industries and technologies.

The accompanying diagram (FIG. 1) illustrates a conceptual depiction of the Dynamic Gist-Based Memory Model (DGMM) designed to facilitate the organization, persistence, and interaction of memory constructs for dynamic and scalable applications. The model operates through four primary stages: Data Collection, Data Persistence, Data Extraction, and Real-Time Analysis. Each of these stages interacts seamlessly to ensure efficient representation and use of memory constructs. This DGMM Memory Model, described in accordance with one embodiment of the present invention, enables the representation of concepts within a structured graph-based system.

### Core Components of the Memory Model

The diagram provided in FIG. 1 represents a detailed graph-based Memory Model for capturing and organizing concepts, their components, and their relationships. This model illustrates how concepts are linked to sources, interactions, time, and elements like subjects, objects, actions, and modifiers. This Memory Model serves as the gateway to the Data Persistence stage. The diagram in FIG. 1 illustrates the relationships between key nodes—Concept (101), Source (102), Interaction (103), Element (104), and Time (105)—and their associated properties and relationships.
a. Concept Node (101):
   The Concept node represents an abstract encapsulation of a memory construct provided to the system through the Data Collection stage. This node includes the following minimum properties as defined by the Memory Manager Interface:
      i. Source: The origin entity that provides the concept.
      ii. Subject: The subject of the concept.
      iii. Object (optional): The object associated with the concept.
      iv. Action: The verb or action being described in the concept.
      v. Modifiers (optional): Adjectives, adverbs, or other qualifiers for the subject, object, and action.
      vi. Time (optional): The timestamp or timeframe associated with the concept.
      vii. Interaction (optional): A session or grouping context for the concept, identified by an interaction ID. If the interaction is not provided, the system will generate is unique identifier.
   The Concept node allows for additional properties to extend its representation, such as a trustworthiness score that ranges from −1 to 1, where 0 indicates neutrality or unknown veracity.
b. Source Node (102):
   The Source node represents the originator of the concept. Its minimum property is a name, which does not need to be unique. Instead, the system uses an internal ID to establish uniqueness. The Source node can engage in multiple Interactions (103) and recount multiple Concepts (101).
c. Interaction Node (103):
   The Interaction node represents a session during which one or more concepts are recounted by one or more sources. Each Interaction is uniquely identified by an Interaction ID and has relationships such as:
      i. IS_PARTICIPANT: Linking a Source (102) to the Interaction.
      ii. INCLUDES: Linking one or more Concepts (101) to the Interaction.
      iii. STARTED_AT and ENDED_AT: Connecting the Interaction to specific Time nodes (105) to indicate its duration.
d. Element Node (104):
   The Element node represents individual components of a concept, such as subjects, objects, actions, and their modifiers. Relationships between the Concept node (101) and Element nodes (104) include:
      i. HAS_SUBJECT: Linking the Concept's subject to its corresponding Element node.
      ii. HAS_OBJECT: Linking the Concept's object to its corresponding Element node.
      iii. HAS_ACTION: Linking the Concept's action to its corresponding Element node.
      iv. MODIFY_SUBJECT, MODIFY_OBJECT, MODIFY_ACTION: Linking the Concept's modifiers to their respective elements.
   Element nodes can also have hierarchical relationships through HAS_ELEMENT, allowing for decomposition into sub-elements.
e. Time Node (105):
   The Time node represents temporal information associated with the acquisition or occurrence of a concept or interaction. Relationships include:
      i. ACQUIRED: Linking the Concept node (101) to the time it was captured.
      ii. OCCURS: Linking the Concept node (101) to the time the event took place.
      iii. STARTED_AT and ENDED_AT: Defining the temporal boundaries of an Interaction node (103).
   Each Time node is unique within the Memory Model, but the format of the time data is flexible.

The core components of the DGMM, including the Concept Node, Source Node, Interaction Node, Element Node, and Time Node, collectively provide a robust framework for structuring and managing thoughts within the invention. These components are designed to capture, organize, and relate data elements in a graph-based format, ensuring scalability, flexibility, and precision in memory representation.
a. The Concept Node serves as the central entity, encapsulating the core thought and its relationships.
b. The Source Node identifies the origin of the concept, ensuring traceability and accountability.
c. The Interaction Node groups related concepts within sessions or contexts, providing a logical framework for managing complex interactions.
d. The Element Nodes represent the discrete components of a concept, such as subjects, objects, actions, and modifiers, enabling fine-grained semantic representation.
e. The Time Node ensures temporal accuracy by linking concepts and interactions to specific timestamps.

These components work in unison to create a dynamic, adaptable, and efficient DGMM that forms the foundation of the invention's ability to handle, persist, and retrieve structured thoughts. Their integration underscores the invention's innovative approach to memory management, ensuring it meets the demands of diverse applications while maintaining logical coherence and extensibility.

### Illustrative Example

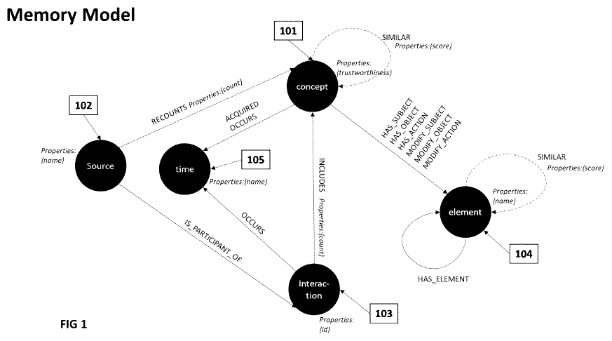

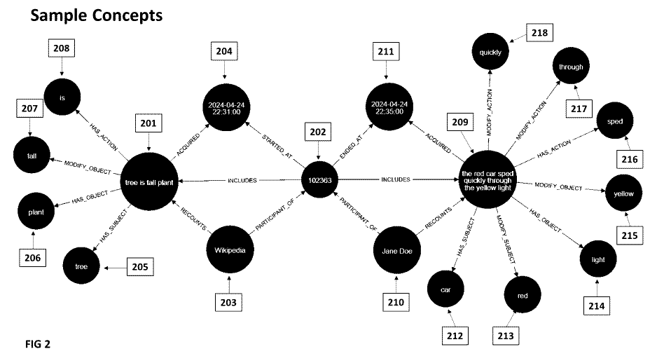

For demonstration purposes, consider the following concepts as illustrated in FIG. 2:
a. Concept: “A tree is a tall plant.” (201)
   i. Source: Wikipedia (203)
   ii. Subject: tree (205)
   iii. Object: plant (206)
   iv. Object Modifier: tall (207)
   v. Action: is (208)
   vi. Concept Acquisition Time: 2024-04-24 22:31:00 (204)
   vii. Interaction: 102363 (202)
   viii. Interaction Start Time: 2024-04-24 22:31:00 (204)
   ix. Interaction End Time: 2024-04-24 22:35:00 (211)
b. Concept: “The red car sped quickly through the yellow light.” (209)
   i. Source: Jane Doe (210)
   ii. Subject: car (212)
   iii. Subject Modifier: red (213)
   iv. Object: light (214)
   v. Object Modifier: yellow (215)
   vi. Action: sped (216)
   vii. Action Modifiers: quickly, through (218,217)
   viii. Concept Acquisition Time: 2024-04-24 22:35:00 (211)
   ix. Interaction: 102363 (202)
   x. Interaction Start Time: 2024-04-24 22:31:00 (204)
   xi. Interaction End Time: 2024-04-24 22:35:00 (211)

The diagram provided in FIG. 2 represents an example of the detailed graph-based DGMM for capturing and organizing concepts, their components, and their relationships. This diagram demonstrates a realistic view of how concepts are linked to sources, interactions, time, and elements like subjects, objects, actions, and modifiers.

### Explanation of Key Components

a. Concept Nodes (201, 209):
   The central nodes in this model represent concepts:
      i. Node 201: “tree is tall plant”
      ii. Node 209: “the red car sped quickly through the yellow light”
      iii. These concept nodes encapsulate the relationships and properties of each concept as captured by the system.
b. Source Nodes (203, 210):
   i. 203 (Wikipedia): Represents the source that recounted the concept “tree is tall plant”.
   ii. 210 (Jane Doe): Represents the source that recounted the concept “the red car sped quickly through the yellow light”.
   iii. The RECOUNTS relationships link each source to its respective concept. These nodes represent the origin of the concepts and can engage in multiple interactions.
c. Interaction Node (202):
   i. Represents a session or contextual grouping where concepts are associated with one or more sources.
   ii. The INCLUDES relationships link the interaction node to the concepts it contains (nodes 201 and 209).
   iii. The PARTICIPANT_OF relationships connect the sources (203, 210) to the interaction, showing that multiple sources can participate in a single session.
d. Time Nodes (204, 211):
   i. Represent specific timestamps for events related to the concepts or the interaction:
      1. Node 204: Time when the concept “tree is tall plant” was acquired.
      2. Node 211: Time when the concept “the red car sped quickly through the yellow light” was acquired.
   ii. The ACQUIRED relationships connect these time nodes to their respective concept nodes.
   iii. Additional time relationships:
      STARTED_AT (204) and ENDED_AT (211): Define the start and end times of the interaction session (202).
e. Element Nodes (205, 206, 207, 212, 213, 214, 215, 216, 217, 218):
   i. Represent the individual components of each concept:
   ii. Subjects:
      1. Node 205: “tree” (associated with Concept 201).
      2. Node 212: “car” (associated with Concept 209).
   iii. Objects:
      1. Node 206: “plant” (associated with Concept 201).
      2. Node 215: “light” (associated with Concept 209).
   iv. Actions:
      1. Node 207: “is” (associated with Concept 201).
      2. Node 216: “sped” (associated with Concept 209).
   v. Modifiers:
      1. Node 206 (tall): Modifies the object “plant” in Concept 201.
      2. Nodes 213 (red), 214 (yellow): Modify the subject “car” and the object “light”, respectively, in Concept 209.
      3. Nodes 217 (through), 218 (quickly): Modify the action “sped” in Concept 209.
   vi. Each of these nodes is connected to its respective concept via specialized relationships:
   vii. HAS_SUBJECT, HAS_OBJECT, HAS_ACTION: Link the subject, object, and action nodes to the concept.
   viii. MODIFY_SUBJECT, MODIFY_OBJECT, MODIFY_ACTION: Link concept nodes to the elements that modify subjects, objects and actions.

### Relationship's and Connections

The graph illustrates relationships between the nodes as follows:

### Concept-Element Relationships:

a. For Concept 201:
   i. HAS_SUBJECT (tree), HAS_OBJECT (plant), HAS_ACTION (is).
   ii. MODIFY_OBJECT (tall).
b. For Concept 209:
   i. HAS_SUBJECT (car), HAS_OBJECT (light), HAS_ACTION (sped).
   ii. MODIFY_SUBJECT (red), MODIFY_OBJECT (yellow), MODIFY_ACTION (quickly, through).
c. Source-Concept Relationships:
   i. RECOUNTS: Wikipedia (203) recounts Concept 201, and Jane Doe (210) recounts Concept 209.
d. Interaction Relationships:
   i. INCLUDES: Interaction node (202) includes Concepts 201 and 209.
   ii. PARTICIPANT_OF: Sources (203, 210) participate in Interaction 202.
e. Time Relationships:
   i. ACQUIRED: Each concept is linked to a time node representing when it was acquired.
   ii. STARTED_AT/ENDED_AT: The interaction is linked to time nodes marking its beginning and end.

### Example Walkthrough

f. Concept 1: “tree is tall plant”
   i. Source (203): Wikipedia recounts this concept.
   ii. Interaction (202): The concept is part of an interaction.
   iii. Elements:
      1. Subject: “tree”
      2. Object: “plant” (modified by “tall”).
      3. Action: “is”
g. Concept 2: “the red car sped quickly through the yellow light”
   i. Source (210): Jane Doe recounts this concept.
   ii. Interaction (202): The concept is part of the same interaction as Concept 1.
   iii. Elements:
      1. Subject: “car” (modified by “red”).
      2. Object: “light” (modified by “yellow”).
      3. Action: “sped” (modified by “quickly” and “through”).

### Utility of the DGMM

This diagram in FIGS. 1 and 2 provide a graph-based representation of the DGMM, showcasing:
a. The ability to capture and organize concepts.
b. Relationships between sources, interactions, and elements.
c. Detailed componentization of concepts for flexibility and extensibility.
d. Temporal and session-based grouping for scalability in memory representation.

This model supports robust handling of memory constructs while maintaining flexibility for diverse use cases.

### Properties and Scalability

The scalability and properties of the core components within the DGMM are fundamental to the invention's ability to manage and process a wide range of thoughts effectively. By leveraging modular components such as the Concept Node, Source Node, Interaction Node, Element Node, and Time Node, the invention ensures flexibility in handling diverse inputs while maintaining a structured and coherent memory representation.

This section explores how these components scale to accommodate large volumes of data, maintain semantic integrity, and support extensibility for various applications. Additionally, it highlights the unique properties of each node, such as traceability through Source Nodes, contextual grouping via Interaction Nodes, and temporal accuracy with Time Nodes. Together, these features demonstrate the invention's capacity to adapt to complex scenarios while preserving efficiency and consistency.

The DGMM has minimum criteria for node instantiation:
a. The names of the nodes and relationships are not fixed but are described here to facilitate understanding of the model structure
b. Element nodes (104): Must have a unique name within the DGMM.
c. Time nodes (105): Must also be unique but have no prescribed format.
d. Source, Interaction, and Concept nodes: Must have unique IDs.

The model supports scalability, allowing for:
a. Multiple Interactions within a single DGMM.
b. Multiple Sources participating in an Interaction.
c. Grouping of Concepts within sessions or other contexts.
d. Multiple connections between an Element Node and Concept Nodes
e. Supports reacquisition of the same concept

All references to the ‘Memory Model’ within this application explicitly refer to the proprietary Dynamic Gist-Based Memory Model (DGMM) described herein. The DGMM is uniquely characterized by its gist-based storage mechanism, dynamic contextual retrieval processes, predefined semantic relationships among nodes, and integration of temporal and source metadata. This DGMM is distinct from generic or prior art systems and is integral to the functionalities and claims of the present invention.

### Concept Ingestion

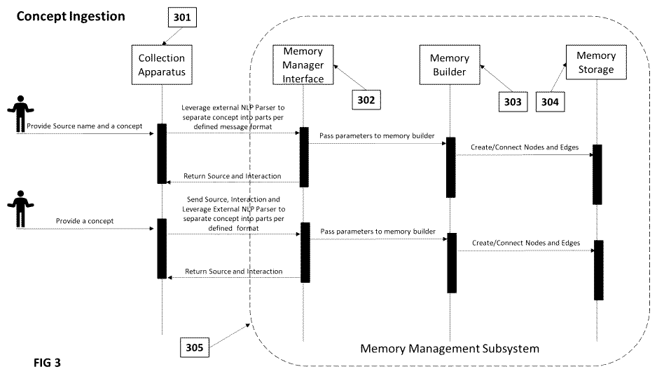

The diagram in FIG. 3 illustrates an embodiment of the invention, demonstrating how the DGMM is leveraged to collect, process, and persist concepts into a structured graph-based representation. This embodiment provides a novel system for organizing memory constructs into a modular, scalable, and extensible framework, ensuring efficient storage, retrieval, and analysis of concept data. The system comprises multiple interrelated components: the Collection Apparatus (301), Memory Manager Interface (302), Memory Builder (303), and Memory Storage (304), which together form a cohesive architecture. The dotted boundary (305) delineates the internal scope of the system, encapsulating the components that directly implement the Memory Model.

The names and labels assigned to the components in this embodiment, such as ‘Collection Apparatus,’ ‘Memory Manager Interface,’ ‘Memory Builder,’ and ‘Memory Storage,’ are not fixed and are provided solely for the purpose of facilitating understanding of the invention. These names are descriptive and may be substituted with alternative terms without departing from the scope, intent, or functionality of the invention.

### Core Components and Their Functions

a. Collection Apparatus (301):
   The Collection Apparatus is the external interface that receives syntactic representations of concepts from external entities. These representations can include concepts such as “tree is a tall plant” or “the red car sped quickly through the yellow light”.
      i. Functionality:
         1. Collects concepts as syntactic representations without parsing or interpreting their meaning.
         2. Forwards the collected data to the Memory Manager Interface (302) in a designated format for validation and processing.
      ii. Advantages:
         By not requiring internal parsing, the Collection Apparatus allows external entities to retain control over the contextual interpretation and translation into the memory manager interface. This flexibility ensures that the system can accommodate a variety of syntactic structures and use cases.
      iii. The Collection Apparatus introduces a novel mechanism for receiving and transmitting syntactic representations while maintaining separation of concerns by offloading interpretation to external entities.
b. Memory Manager Interface (302):
   i. This is a pivotal module in the embodiment, functioning as the gateway to the Memory Model. It validates, translates, and routes incoming concepts to the Memory Builder (303).
   ii. Key Functions:
      1. Validation: Ensures that each concept meets the minimum requirements, including:
         a. Source: The origin entity providing the concept (e.g., “Wikipedia” or “Jane Doe”).
         b. Subject: The subject of the concept (e.g., “tree” or “car”).
         c. Action: The verb or action describing the relationship (e.g., “is” or “sped”).
         d. Optional Modifiers: Adjectives, adverbs, and other qualifiers.
         e. Optional Relationships: Time of occurrence, interactions, and grouping contexts.
      2. Translation:
         Decomposes syntactic representations into discrete components,
         preparing them for graph construction.
      3. Routing:
         Passes validated components to the Memory Builder (303).
      4. The Memory Manager Interface provides a novel and modular mechanism for ensuring that incoming concepts meet structural integrity requirements while preparing them for graph-based representation. Its validation and translation functions enable seamless integration with the Memory Model, ensuring consistency and compatibility.
c. Memory Builder (303):
   i. The Memory Builder constructs the graph-based Memory Model, a central aspect of the invention. This module creates the nodes and relationships that represent the concept within the memory graph.
   ii. Key Responsibilities:
      1. Node Creation: Constructs nodes for the concept, source, subject, object, action, modifiers, time, and interactions.
      2. Relationship Definition: Establishes semantic relationships, including:
         a. HAS_SUBJECT: Links the concept to the subject node.
         b. HAS_OBJECT: Links the concept to the object node.
         c. MODIFY_SUBJECT, MODIFY_OBJECT, MODIFY_ACTION: Links modifiers to their respective components.
         d. RECOUNTS: Links the source to the concept.
         e. INCLUDES: Links interactions to concepts.
      3. Attribute Assignment:
         Assigns properties to nodes and relationships, such as trustworthiness scores, timestamps, and unique IDs.
      4. The Memory Builder introduces a unique approach to constructing graph-based representations of memory constructs. Its capability to define nodes, relationships, and attributes in a modular and extensible manner ensures the invention's applicability across diverse domains.
d. Memory Storage (304):
   i. The Memory Storage component provides long-term persistence for the memory graph constructed by the Memory Builder (303). It ensures the availability and integrity of memory constructs for retrieval, updates, and analysis.
   ii. Key Features:
      1. Persistence: Safeguards the graph structure in a scalable format.
      2. Scalability: Accommodates large, complex memory graphs involving multiple sources, interactions, and concepts.
      3. Query and Retrieval: Supports efficient queries to extract nodes, relationships, or subgraphs for real-time analysis.
   iii. The Memory Storage module introduces a robust mechanism for preserving and retrieving graph-based memory constructs. Its scalability and query capabilities enhance the invention's utility for applications requiring persistent memory representations.
e. System Boundary (305):
   i. The dotted boundary labeled 305 demarcates the internal components of the invention that directly implement and leverage the Memory Model. These include the Memory Manager Interface (302), Memory Builder (303), and Memory Storage (304).
   ii. The Collection Apparatus (301) exists outside this boundary to emphasize its role as the external gateway to the system.
   iii. The system boundary separates internal memory processing from external input collection, ensuring modularity and clarity in the architecture while protecting the unique integration of these components.

The concept ingestion process, as depicted in FIG. 3, demonstrates how the invention integrates core components, such as the Memory Manager Interface, Memory Storage, and System Boundary, to efficiently transform raw input into structured, graph-based memory representations. This process ensures that incoming data is validated, decomposed, and organized into modular components for scalable and extensible memory management.

The Memory Manager Interface serves as the gateway for concept ingestion, receiving raw input from external sources and validating it against minimum structural requirements. It decomposes the input into discrete elements, such as the Source Node, which captures the origin of the concept, and the Concept Node, which represents the central idea. Additional components, such as Element Nodes (e.g., Subject, Object, Action, and Modifiers), provide fine-grained detail, while the Interaction Node groups related concepts within a contextual framework. The Time Node ensures that the concepts are temporally anchored, capturing when they were acquired or occurred.

The processed and validated data is then passed to the Memory Storage subsystem, where it is persisted as the DGMM graph-based representation. This storage architecture supports scalability, allowing the system to handle complex and large-scale memory constructs while enabling efficient retrieval for downstream applications. The System Boundary delineates the external Collection Apparatus from the internal processing components, ensuring modularity and security in the concept ingestion process.

This modular and scalable architecture, as highlighted in FIG. 3, demonstrates the invention's innovative approach to memory management. By leveraging the core components and maintaining a clear system boundary, the invention ensures flexibility, precision, and efficiency in the ingestion and organization of concepts, providing a strong foundation for advanced memory management capabilities. This architecture along with the DGMM model can support multiple parallel processes or interactions between external data collectors and the system.

### Flow of Data in Concept Ingestion

FIG. 3 illustrates the flow of data for the concept ingestion process, showcasing how raw input is transformed into structured, graph-based representations within the Memory Model. This process begins with the Collection Apparatus, which receives input from external sources and passes it through the Memory Manager Interface for validation and decomposition. The data is then processed into modular components such as Source Nodes, Concept Nodes, Element Nodes, Interaction Nodes, and Time Nodes, which collectively form a robust and scalable memory structure.

The flow of data highlights the integration of key components, including the Memory Storage Subsystem, where validated concepts are persisted using the DGMM, and the System Boundary, which ensures the modularity and security of the process by separating external input from internal processing. FIG. 3 also emphasizes the relationships between these components, demonstrating how they collaborate to ensure precision, scalability, and contextual relevance in the ingestion of concepts.

The following sections detail each step in the flow of data, as depicted in FIG. 3, highlighting the roles of the core components and their interactions.
a. Input:
   External entities provide syntactic representations of concepts via the Collection Apparatus (301).
b. Processing:
   The Memory Manager Interface (302) validates and decomposes the input into graph-compatible components.
c. Graph Construction:
   The Memory Builder (303) creates nodes and relationships, constructing the graph-based Memory Model.
d. Persistence:
   The constructed graph is stored in Memory Storage (304) for long-term use.

### Innovative Features of Concept Ingestion

The embodiment of this portion of the invention has a novel approach to collecting and storing concepts.
a. Separation of Concerns:
   The invention modularly separates input collection, validation, graph construction, and storage, ensuring flexibility and extensibility.
b. Graph-Based Representation:
   The Memory Model's graph structure provides a scalable and efficient method for organizing memory constructs.
c. Adaptability:
   The invention's modular architecture allows it to accommodate a wide range of syntactic representations and use cases.

The flow of data for concept ingestion, as depicted in FIG. 3, demonstrates the invention's ability to transform raw input into structured, graph-based memory representations through a seamless and modular process. Starting with the Collection Apparatus, which receives and forwards input, the data is validated, decomposed, and organized by the Memory Manager Interface. Key components such as the Source Node, Concept Node, Element Nodes, Interaction Node, and Time Node ensure that each concept is accurately captured, contextualized, and temporally aligned.

The Memory Storage Subsystem provides a scalable and efficient framework for persisting these structured concepts, while the System Boundary delineates the separation between external input collection and internal processing. This flow ensures that the system can handle diverse and complex inputs while maintaining the modularity, scalability, and precision required for effective memory management.

By leveraging these interconnected components and processes, the invention ensures the robust ingestion of concepts into a dynamic and extensible Memory Model. This process not only lays the foundation for downstream tasks such as retrieval and thought generation but also underscores the invention's innovative approach to managing and organizing complex data.

This embodiment protects the invention's novelty by detailing how the Collection Apparatus, Memory Manager Interface, Memory Builder, and Memory Storage collaboratively leverage the DGMM to achieve robust, scalable, and modular memory representation.

### Memory Recall Manager and Retrieval Mechanism

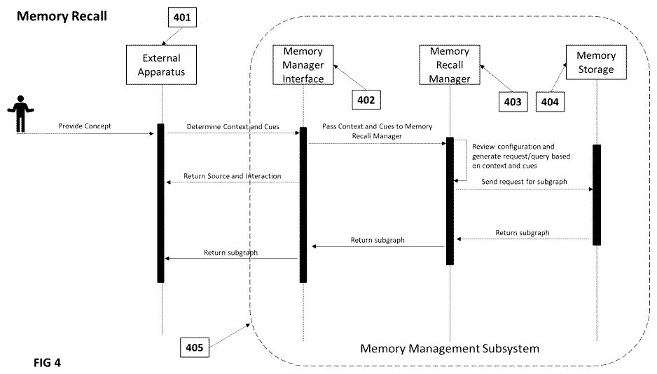

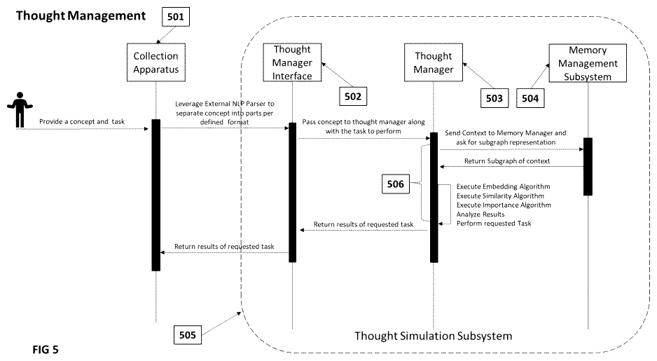

The Memory Recall Manager and Retrieval Mechanism introduces an advanced system for efficiently retrieving structured memory constructs from the Dynamic Gist-Based Memory Model (DGMM). As illustrated in FIG. 4, this system integrates multiple modular components, including the External Apparatus (401), Memory Manager Interface (402), Memory Recall Manager (403), and Memory Storage (404), all functioning within a clearly defined System Boundary (405). This boundary ensures secure and seamless interaction between external systems and internal processes, enabling real-time and contextually relevant memory retrieval. The invention's novel approach focuses on leveraging context cues to selectively access portions of stored memory for immediate processing, offering unparalleled flexibility and adaptability.

The External Apparatus (401) serves as the system's interface for collecting syntactic representations of concepts from external sources. It transmits input, such as “The red car sped quickly through the yellow light,” to the Memory Manager Interface (402). Inputs include structured elements like source (“Jane Doe”), subject (“car”), action (“sped”), and modifiers (“red,” “quickly,” “through,” “yellow”). By isolating the input collection process from internal memory management, the apparatus ensures adaptability across diverse data sources and formats.

The Memory Manager Interface (402) acts as a gateway, validating and transforming the received input into graph-compatible components for integration into the DGMM. Validation ensures that each input includes the required elements, such as a source, subject, action, and optional modifiers, while the transformation process decomposes inputs into nodes and relationships compatible with the DGMM. This interface routes validated data to the Memory Recall Manager (403) for retrieval or the Memory Storage (404) for persistence, enabling a modular and efficient flow of information within the system.

The Memory Recall Manager (403) is the central component for retrieving stored memory constructs. It processes advanced queries using contextual cues to locate and return relevant data. For instance, a query about “Jane Doe” and “car” retrieves information where “Jane Doe” is the source and any concept linked with a “car” element. It then retrieves all associated concepts, such as “The red car sped quickly through the yellow light,” along with concepts linked a configurable n-degrees out. The recall manager employs graph traversal techniques to navigate the DGMM, efficiently identifying nodes and relationships (e.g., HAS_SUBJECT, HAS_OBJECT, MODIFY_ACTION) that are contextually relevant. By integrating retrieved data into real-time processes, this component ensures practical applicability across domains requiring immediate insights.

The Memory Storage (404) component provides a persistent and scalable graph-based structure for storing all memory constructs. It ensures long-term retention and accessibility, supporting large-scale implementations with multiple sources, interactions, and concepts. The storage system optimizes retrieval operations by indexing graph components, allowing for fast and efficient data access. This scalability enables the system to manage complex and diverse memory graphs without compromising performance or reliability.

The System Boundary (405) delineates the internal components of the invention, including the Memory Manager Interface, Memory Recall Manager, and Memory Storage, from the external input interface provided by the External Apparatus. This separation ensures modularity, security, and adaptability, allowing the system to evolve independently of external data sources.

The memory recall process, as depicted in FIG. 4, highlights the invention's ability to transform contextually relevant queries into actionable outputs. Input begins with the External Apparatus, which forwards syntactic representations to the Memory Manager Interface for validation and transformation. The validated data is then routed to the Memory Recall Manager, which uses advanced graph traversal techniques to locate and retrieve relevant portions of the DGMM. Retrieved data is dynamically integrated into ongoing processes, supporting real-time applications such as decision-making or context-aware computing.

This embodiment demonstrates the system's innovative capabilities in context-aware retrieval, leveraging the DGMM to provide efficient and precise access to stored memory constructs. By using contextual cues like source, subject, or interaction, the Memory Recall Manager dynamically selects the most relevant portions of memory, enhancing its utility. Furthermore, the modular design ensures scalability and extensibility, making it adaptable to various applications, from real-time analytics to intelligent decision-making systems.

The invention's reliance on a graph-based Memory Model provides a robust framework for organizing and retrieving memory constructs. Its modular components ensure separation of concerns, isolating input collection, validation, storage, and retrieval processes. By integrating real-time recall capabilities with scalable storage and advanced query management, the memory recall mechanism transforms stored data into actionable insights. This approach not only preserves memory constructs but also ensures their relevance and usability in diverse and complex scenarios.

### Thought Management Subsystem Capability

The Thought Management Subsystem, as depicted in FIG. 5, embodies an advanced system designed to generate, organize, and persist structured thoughts by processing external inputs into meaningful constructs. This subsystem operates through a modular architecture that integrates the Collection Apparatus (501), Thought Manager Interface (502), Thought Manager (503), and Memory Management Subsystem (504). These components collectively enable the transformation of raw input into contextually enriched thoughts while ensuring scalability, adaptability, and efficient storage. The subsystem's modularity is underscored by a clear System Boundary (505), which separates external input processes from internal thought generation and memory management.

The Collection Apparatus (501) serves as the external interface for receiving unprocessed data from various sources. By forwarding this raw input-such as “A tall tree provides shade to a small bench”—to the Thought Manager Interface (502) leveraging the Memory Manager Interface, the apparatus ensures flexibility and compatibility with diverse data formats. Input components such as the source, subject, action, and modifiers are preserved, enabling downstream processes to utilize this foundational information for thought generation. This separation of data collection from processing ensures adaptability to a wide range of external contexts.

The Thought Manager Interface (502) validates and prepares incoming data for integration into the system. Validation ensures that the input meets the minimum structural requirements, including the presence of subjects, actions, objects, and relevant modifiers. Following validation, the interface translates raw data into structured, graph-compatible components suitable for the DGMM. These prepared components are then routed to the Thought Manager (503) for synthesis. This intermediary role of the interface guarantees that only actionable, well-structured data enters the thought generation process, enhancing system reliability and efficiency.

At the heart of the subsystem, the Thought Manager (503) synthesizes enriched thoughts by combining validated data with contextual reasoning. This process involves creating graph nodes for the core elements of the thought and establishing semantic relationships such as HAS_SUBJECT, HAS_OBJECT, and MODIFY_ACTION. The Thought Manager employs advanced reasoning mechanisms to refine or expand upon the input, ensuring that the resulting thoughts are actionable, meaningful, and contextually aligned. This capability to incorporate logical synthesis and contextual cues is a key innovation, enabling real-time generation of thoughts that are tailored to specific scenarios.

The Memory Management Subsystem (504) ensures the persistence of generated thoughts by storing them in the DGMM's graph-based memory structure. This component supports the long-term retention of thoughts, making them accessible for future retrieval, further refinement, or real-time applications. By indexing graph nodes and relationships, the subsystem facilitates efficient queries and rapid access to stored information, ensuring that memory constructs remain organized and readily usable.

The System Boundary (505) delineates the external input interface from internal processes, emphasizing the subsystem's modular nature. This separation enhances security, scalability, and adaptability, allowing the internal components-such as the Thought Manager and Memory Management Subsystem—to operate independently of external data sources. This design ensures that the system can evolve or expand without disrupting its foundational processes.

The data flow within the Thought Management Subsystem exemplifies its seamless integration of collection, validation, synthesis, and storage. Input data is first gathered by the Collection Apparatus (501) and forwarded to the Thought Manager Interface (502) for validation and translation. The structured data is then synthesized into new thoughts by the Thought Manager (503) and stored in the Memory Management Subsystem (504) for future use. This systematic process ensures that the subsystem can handle diverse inputs, generate novel constructs, and retain them efficiently for a variety of applications.

Key features of the subsystem include its ability to generate contextually enriched thoughts, its modular design that supports diverse input formats, and its reliance on the DGMM for semantic organization and efficient retrieval. The capability to leverage context cues during thought synthesis represents a novel aspect of the system, enabling it to dynamically select and process portions of memory relevant to ongoing tasks. This innovation facilitates real-time decision-making and adaptability, ensuring the utility of the subsystem across domains such as data processing, knowledge management, and contextual reasoning.

Conventional systems for contextual reasoning and data analysis often rely on supervised learning approaches, which require large volumes of labeled datasets and pretraining to function effectively. These methods are well-suited for static and narrowly defined tasks but face significant limitations in dynamic environments where labeled data is unavailable or impractical to obtain. Moreover, supervised systems lack the flexibility to adapt to real-time changes in data without extensive retraining, resulting in high computational overhead and reduced scalability.

The Dynamic Gist-Based Memory Model (DGMM) overcomes these challenges by operating in a fully unsupervised manner. Unlike supervised methods, the DGMM leverages its internal graph-based structure to analyze and process data dynamically, without the need for pretraining or human-labeled inputs. Subgraphs are retrieved based on context cues derived from nodes, relationships, and metadata within the model, and downstream operations such as embedding generation, similarity computation, and clustering are performed directly on these subgraphs. This unsupervised approach enables the system to adapt in real time, offering greater flexibility and scalability across a variety of use cases.

In addition to its unsupervised operation, the DGMM supports iterative reasoning by integrating system-generated propositions back into the model. These propositions, marked explicitly as system-sourced, can act as new context cues for subsequent reasoning tasks. This feedback loop further enhances the system's ability to operate autonomously, addressing dynamic and evolving data streams effectively.

The Thought Management Subsystem underscores the invention's potential to revolutionize how structured thoughts are generated, stored, and utilized. Its modular architecture, scalability, and reliance on the DGMM ensure that it can accommodate complex and unstructured inputs while maintaining efficiency and precision. By bridging the gap between raw input and actionable thought constructs, the subsystem offers a robust solution for dynamic memory management, setting a new standard for processing and leveraging complex information.

### Contextual Concept Retrieval and Similarity Analysis Using the DGMM Memory Model

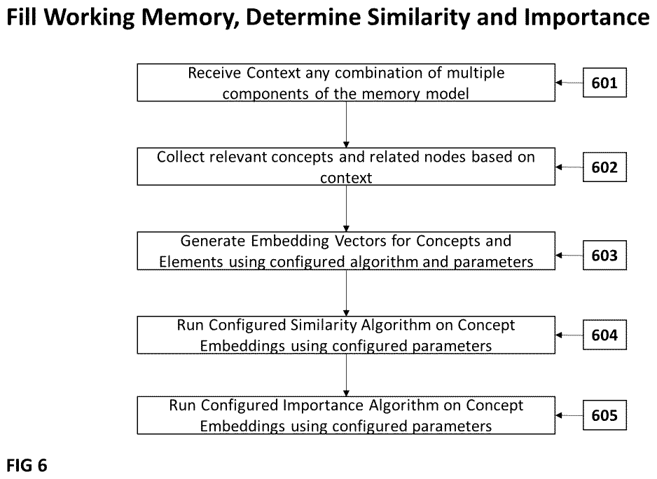

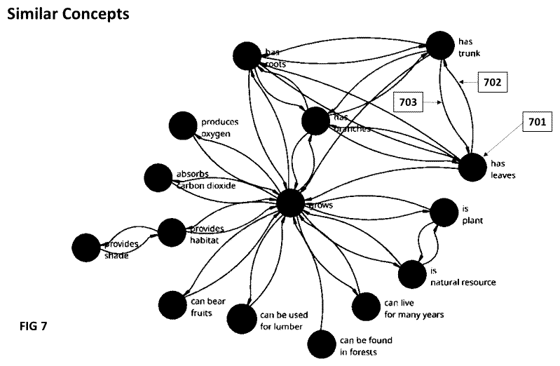

The Contextual Concept Retrieval and Similarity Analysis Using the DGMM Memory Model, illustrated in FIG. 6, highlights an innovative embodiment designed to enable the retrieval, analysis, and prioritization of concepts based on contextual input. Leveraging the graph-based architecture of the Dynamic Gist-Based Memory Model (DGMM), this process dynamically collects and analyzes data to ensure that outputs are contextually relevant and actionable. The modular system operates through five sequential stages (601-605) that utilize fast graph embedding algorithms, such as FASTRP, and similarity measures, including K-Nearest Neighbors (KNN), to deliver precise and scalable results.

The process begins with the Receive Context (601) stage, where the system accepts contextual input that defines the scope of the analysis. This input may include Memory Model components such as Source, Subject, Object, Action, Modifiers, Time, or Interaction. The Memory Manager Interface processes this input, ensuring flexibility to handle a wide range of queries, from broad topics to highly detailed inquiries. By aligning the context with structured data in the Memory Model, this step establishes the foundation for subsequent stages.

In the Collect Relevant Concepts and Nodes (602) stage, the system traverses the DGMM to identify nodes that align with the provided context. These nodes include Concept Nodes, Source Nodes, Interaction Nodes, Element Nodes, and Time Nodes, among others. The DGMM's graph-based structure ensures that relationships between these nodes are maintained, enabling the collection of semantically meaningful and contextually accurate data. This stage relies heavily on the DGMM to provide the framework for isolating and retrieving relevant information efficiently.

The Generate Embedding Vectors for Concepts and Elements (603) stage transforms the collected nodes into numerical vectors using a configurable embedding algorithm such as FASTRP. These embeddings capture the semantic and contextual relationships within the DGMM, preserving the integrity of the connections between nodes while enabling computational efficiency. The flexibility of the embedding algorithm ensures adaptability to diverse use cases, allowing the system to tailor its processing to specific requirements.

In the Run Configured Similarity Algorithm (604) stage, a similarity algorithm such as KNN is applied to the generated embeddings. This algorithm evaluates the alignment of retrieved concepts with the input context by comparing their vector representations. The DGMM ensures that these comparisons remain semantically grounded, as its structured relationships provide the foundation for relevance analysis. The configurability of the similarity algorithm allows for application-specific adjustments, enhancing the system's adaptability.

The process concludes with the Run Optional Configured Importance Algorithm (605) stage, where the system ranks concepts based on their contextual importance. The importance algorithm processes the embedding vectors and relevance scores, emphasizing temporal, relational, and semantic factors derived from the DGMM. This ranking ensures that outputs are prioritized according to their contextual alignment and actionable value.

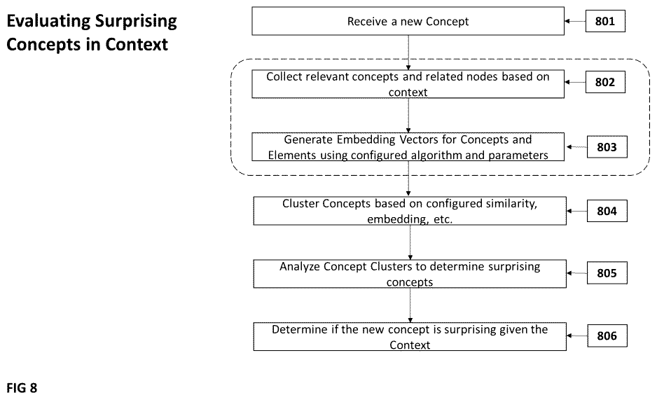

FIG. 7 provides a detailed example of this process, using “tree” as the central concept or context cue. The system begins by collecting nodes related to “tree” within the DGMM, exploring connections up to n degrees to include directly and indirectly related nodes. Examples of collected nodes include “produces oxygen,” “provides shade,” “can bear fruits,” and “is a natural resource.” These nodes are embedded into vectors using the configurable embedding algorithm, capturing their relationships and contextual properties.

The similarity algorithm then computes similarity scores for each node relative to “tree,” identifying the most relevant concepts. For instance, nodes like “provides shade” and “produces oxygen” may exhibit strong semantic alignment with “tree” and are prioritized in the output. The system visualizes these nodes and their relationships in a graph-based format, as shown in FIG. 7, providing a clear and actionable representation of the strongest semantic connections.

This embodiment demonstrates several key advantages. The dynamic node collection enables the system to explore varying depths of connections, ensuring scalability. The embedding algorithm effectively captures semantic relationships, enabling precise similarity analysis. The similarity computation ensures that outputs are contextually aligned, while the graph-based visualization offers a concise and interpretable representation of relevant concepts.

The system's ability to leverage the DGMM's graph structure and integrate advanced algorithms like FASTRP and KNN sets it apart. By dynamically analyzing and prioritizing semantically similar concepts, it efficiently handles complex relationships and delivers contextually enriched insights. The modular and scalable design ensures adaptability to diverse applications, from knowledge retrieval to decision support, underscoring the system's innovative approach to memory-based contextual analysis. FIGS. 6 and 7 collectively highlight the system's capacity to transform raw context into actionable and semantically relevant outputs, making it a robust tool for managing and analyzing structured data.

### Detecting Surprising Concepts

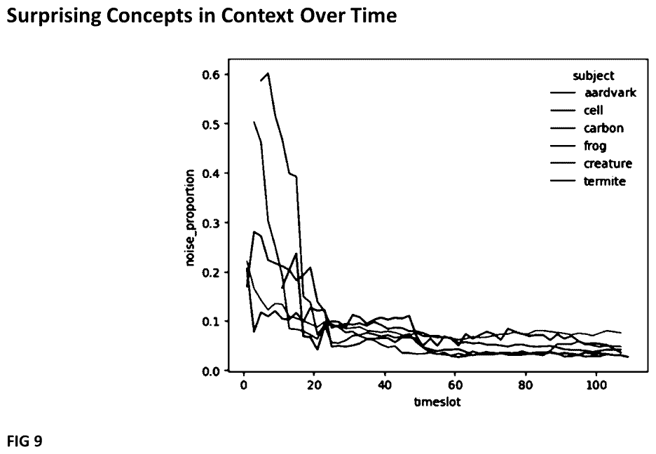

The Identifying Surprising Concepts process, as illustrated in FIG. 8, highlights the system's innovative ability to analyze newly received concepts within the Dynamic Gist-Based Memory Model (DGMM) and assess their alignment with existing contextual norms. By leveraging dynamic clustering, semantic similarity analysis, and contextual evaluation, the system determines whether a concept is surprising based on its deviation from established patterns. This embodiment combines configurable algorithms such as FASTRP for fast graph embeddings and DBSCAN for clustering to enable real-time analysis and provide actionable insights.

The process begins with Step 1: Receive a New Concept (801), where the system accepts new data inputs, which may include attributes like Subject, Object, Action, Modifiers, Time, and Context. These inputs, originating from user interactions, external systems, or data streams, are dynamically integrated into the Memory Model for further analysis. The flexibility of this step ensures that the system can handle diverse input types, enabling continuous adaptation and relevance.

In Step 2: Embed and Contextualize the New Concept (802-803), the system processes the new concept by first generating a vector representation using a configurable embedding algorithm such as FASTRP. This embedding captures semantic relationships and contextual alignments between the new concept and existing elements in the DGMM. The contextual mapping stage further integrates the embedded concept into the Memory Model by aligning it with relevant nodes and relationships. These steps ensure that the new concept is semantically and contextually grounded, facilitating meaningful analysis.

The Step 3: Cluster Concepts Based on Configured Similarity and Embedding (804) organizes the embedded concept into logical groups alongside related elements. Using DBSCAN, the system clusters concepts based on similarity scores derived from their embedding vectors. These clusters represent semantic relationships, shared attributes, or contextual connections within the Memory Model. The configurability of the clustering algorithm allows the system to adapt to specific application requirements, ensuring precise groupings that highlight patterns and deviations.

In Step 4: Analyze Concept Clusters to Determine Surprising Concepts (805), the system evaluates the clusters to identify concepts that deviate from expected norms. Surprising concepts may emerge as outliers that fail to join a cluster or belong to disproportionately small clusters, indicating their novelty or misalignment. This stage leverages the DGMM's structured relationships to dynamically detect anomalies, providing insights for use cases such as anomaly detection and novelty identification.

Finally, Step 5: Determine if the New Concept is Surprising Given the Context (806) assesses the new concept's alignment with the input context. Factors such as cluster size, cluster membership and noise are considered to evaluate whether the concept adheres to or deviates from expected relationships. This context-aware analysis ensures nuanced assessments, enabling the system to flag truly surprising concepts while maintaining semantic and contextual integrity.

FIG. 9 illustrates the system's capability to track surprising concepts over time. As the DGMM integrates additional data, the number of surprising concepts decreases, reflecting the model's iterative refinement and contextual alignment. Initial spikes in surprises are resolved as the system learns and incorporates new patterns. This visualization demonstrates the system's ability to manage complexity, resolve anomalies dynamically, and adapt to evolving knowledge.

The process's key features include dynamic concept integration, allowing seamless addition and analysis of new data; embedding and contextualization, ensuring semantic alignment; configurable clustering, which adapts to varied similarity criteria; and context-aware analysis, enabling nuanced evaluations tailored to specific scenarios. These features make the system highly versatile for applications requiring real-time anomaly detection, creative reasoning, or adaptive learning.

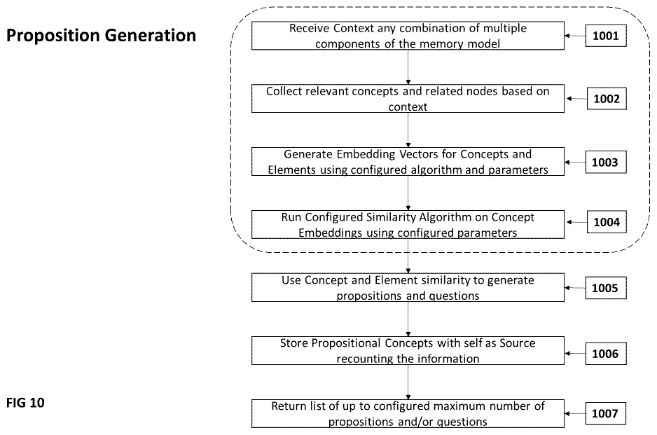

FIG. 10 further exemplifies the system's capability by dynamically generating and storing propositions based on concept similarity. By leveraging semantic relationships within the DGMM, the system creates meaningful propositions that are stored for retrieval, enhancing its utility for knowledge management and decision-making.

The integration of FASTRP for efficient embedding, DBSCAN for robust clustering, and the DGMM's graph-based architecture ensures that the system delivers precise, contextually enriched insights. This novel approach enables organizations to uncover unexpected patterns, refine knowledge dynamically, and respond intelligently to complex and evolving data environments, highlighting its transformative potential across diverse domains.

### Generating Propositions

The Generating Propositions process, as depicted in FIGS. 10, 11 and 12, highlights the system's innovative approach to synthesizing actionable insights by leveraging the Dynamic Gist-Based Memory Model (DGMM). By dynamically combining semantic relationships, context cues, and advanced algorithms such as FASTRP for graph embeddings and KNN for similarity analysis, the system identifies relationships among concepts and generates coherent propositions. These propositions provide strategic recommendations, hypotheses, or exploratory questions tailored to specific queries, enabling the system to deliver real-time, contextually enriched outputs.

The process begins with Step 1: Input and Analysis (1001-1004), where the system receives input in the form of a root concept, associated elements, and contextual information. Using the DGMM's graph structure, the input is embedded and analyzed to identify similarities and contextual relationships among related concepts. This stage aligns with the earlier Concept Similarity process (601-604), ensuring the embedding and similarity measures capture the semantic alignment of concepts within the Memory Model.

In Step 2: Generate Propositions and Questions (1005), the system uses the identified similarities between concepts to synthesize propositions or generate contextually relevant questions. By analyzing the semantic and contextual relationships stored within the DGMM, the system ensures that these outputs are both meaningful and aligned with the input context. This step highlights the system's ability to dynamically adapt to evolving queries while maintaining precision and relevance.

During Step 3: Store Propositional Concepts (1006), the generated propositions are persistently stored as new nodes within the DGMM, allowing for future retrieval or refinement. The system designates itself as the source recounting the information, maintaining the integrity of the Memory Model by distinguishing between externally sourced and internally generated data. This capability ensures that propositions remain available for subsequent analyses, enhancing the system's adaptability and knowledge retention.

In Step 4: Return List of Propositions and Questions (1007), the system retrieves and outputs a configurable number of propositions or questions, enabling efficient access to the most relevant insights. This feature allows for customization based on application-specific requirements, ensuring that outputs are tailored to the needs of downstream processes or user interactions.

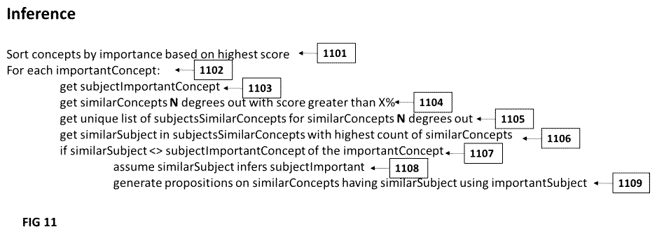

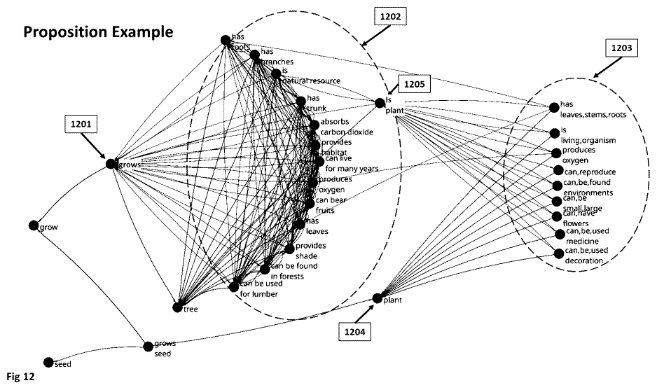

The detailed algorithm for proposition generation, as illustrated in FIG. 11, begins with the identification of a root concept (1101). This concept is selected based on its importance score, derived from the similarity process outlined in FIG. 6. The algorithm then retrieves related concepts (1102, 1103), focusing first on directly related nodes and then extending to indirectly related nodes within a configurable threshold. These connections provide a comprehensive set of semantically aligned elements for proposition generation.

The next stage, Identify Element Relationships (1104-1106), involves analyzing the collected concepts to identify recurring elements and their relationships. Using indirectly related concepts, the algorithm identifies patterns in attributes such as subjects, actions, and modifiers, ensuring that the generated propositions reflect meaningful semantic alignments.

In Check New Subject (1107, 1108), the system evaluates whether elements from indirectly related concepts can replace elements in directly related concepts. For example, if indirectly related concepts share attributes with “tree” but introduce “plant” as a broader subject, the system infers that “tree” and “plant” are semantically aligned, enabling the synthesis of new propositions.

Finally, in Generate Propositions (1109), the algorithm synthesizes new propositions by integrating elements from directly and indirectly related concepts. FIG. 12 illustrates a specific example where the root concept “tree grows” (1201) is directly linked to concepts such as “provides habitat,” “has branches,” and “produces oxygen.” Indirectly related concepts, such as “can reproduce” and “has flowers,” are associated with the broader subject “plant” (1203, 1205). By analyzing these relationships, the system infers propositions like “A tree can reproduce” or “A tree can have flowers,” demonstrating its ability to dynamically synthesize meaningful insights from contextual and semantic patterns.

Key features of this process include its ability to dynamically generate propositions by analyzing relationships between concepts, configurable output to meet diverse application needs, persistent storage of propositions for future reference, and self-recounting of generated insights to maintain Memory Model integrity. These features make the system versatile for applications in knowledge management, automated reasoning, and interactive systems, such as virtual assistants or decision-making tools.

The process leverages advanced algorithms, including FASTRP for efficient graph embeddings and KNN for precise similarity calculations, to identify and cluster semantically aligned concepts. By integrating these capabilities with the DGMM's graph-based architecture, the system dynamically generates contextually relevant propositions that enhance reasoning, decision-making, and strategic foresight. This innovative approach underscores the system's scalability, adaptability, and precision in processing complex relationships, making it a valuable tool across diverse domains.

### Subsystems Communication in Memory Management

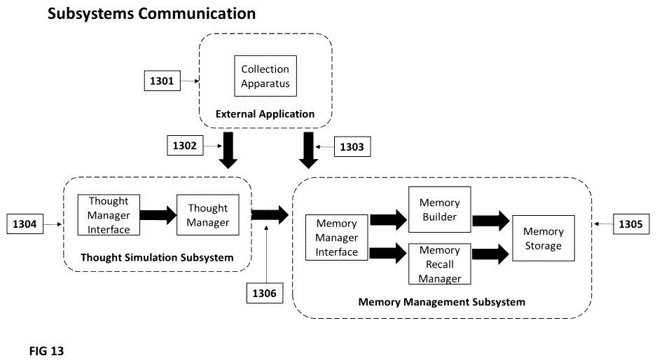

The Subsystems Communication framework, illustrated in FIG. 13, exemplifies the system's innovative architecture, highlighting how its core components interact to manage, process, and analyze information efficiently. The architecture revolves around three primary components: the Collection Apparatus (1301), the Memory Management Subsystem (1305, 1306), and the Thought Simulation Subsystem (1304). Together, these components form a modular and scalable system capable of dynamically integrating and refining data to produce actionable insights.

The Collection Apparatus (1301) serves as the system's entry point, acquiring input data from various external sources. This input may include raw data, structured information, or contextual cues that guide downstream processes. Once collected, the data is transmitted to the Memory Management Subsystem (1305) for organization and processing. This communication ensures that all incoming information is seamlessly integrated into the system, laying the foundation for subsequent analysis.

The Memory Management Subsystem (1305) is the central hub of the architecture, anchored by the Dynamic Gist-Based Memory Model (DGMM). This subsystem organizes, stores, and maintains memory constructs, leveraging several key components to ensure efficient data handling. The Memory Manager Interface (1306) facilitates seamless communication within the subsystem, acting as a gateway for routing data between the Collection Apparatus, the Memory Model, and other subsystems. The Memory Builder constructs and organizes memory structures, embedding semantic relationships and contextual alignments into the DGMM. Meanwhile, the Memory Recall Manager retrieves stored constructs based on queries, enabling real-time processing and analysis. Long-term persistence is provided by Memory Storage, which safeguards memory constructs while supporting iterative and contextual refinement.

The Thought Simulation Subsystem (1304) interacts dynamically with the Memory Management Subsystem to simulate reasoning processes and generate actionable insights. Through the Thought Manager Interface, this subsystem accesses stored and recalled constructs, applying logical synthesis to produce refined thoughts or strategic recommendations. The Thought Manager utilizes retrieved memory constructs to simulate decision-making processes, ensuring that generated outputs are contextually aligned and semantically robust. Communication flows seamlessly from the Memory Manager Interface to the Thought Manager Interface, enabling real-time integration of stored data into higher-order reasoning processes.

The interface between the Memory Management Subsystem and the Thought Management Subsystem facilitates real-time communication. The Memory Management Subsystem retrieves subgraphs based on context cues and transmits the retrieved data, including embeddings and associated properties, to the Thought Management Subsystem. The Thought Management Subsystem processes this data to generate reasoning outputs, such as propositions or surprising concepts, and dynamically updates context cues to refine subsequent subgraph retrievals.

At the core of the architecture, information from the Memory Model is communicated between the subsystems, enabling dynamic processing, semantic alignment, and contextual refinement of information. For example, data collected through the Collection Apparatus is stored into the Memory Model via the Memory Builder, which organizes it into structured constructs. These constructs are accessible to the Thought Simulation Subsystem, where logical reasoning generates actionable propositions or insights. This bidirectional communication ensures that data flows smoothly between components, maintaining coherence and enhancing the system's ability to adapt to diverse use cases.

The modular design of the system supports scalability and adaptability, allowing the architecture to accommodate increasing data volumes and complexity. By enabling seamless communication between subsystems, the framework ensures efficient workflows across knowledge management, automated reasoning, and insight generation. This interconnected design enhances the system's ability to process complex relationships, refine memory constructs iteratively, and produce meaningful outputs tailored to specific contexts.

FIG. 13 demonstrates the system's capacity to integrate disparate components into a unified architecture that prioritizes dynamic interaction and contextual refinement. The communication pathways, such as those between the Collection Apparatus and the Memory Management Subsystem, and between the Memory and Thought Simulation Subsystems, exemplify the architecture's ability to maintain efficiency while managing complex data flows. This innovative communication design positions the system as a robust tool for applications requiring real-time reasoning, adaptive knowledge management, and strategic decision-making.

### Distributed Architecture for Memory Management and Thought Simulation

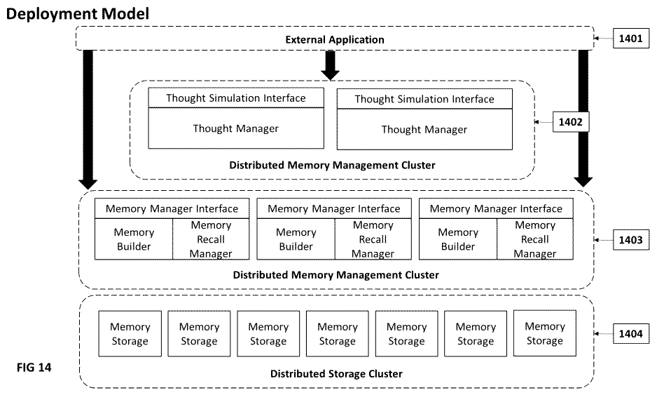

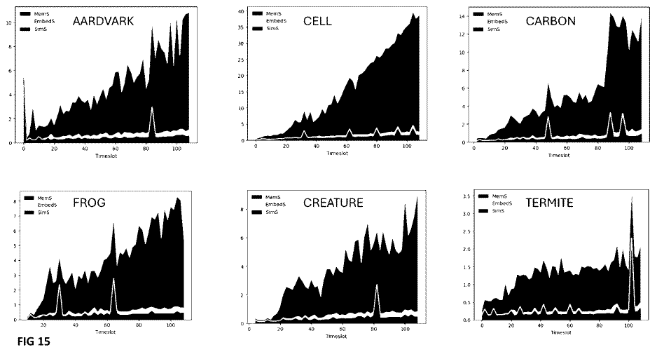

The Distributed Architecture for Memory Management and Thought Simulation Subsystems, as illustrated in FIG. 14, demonstrates the system's ability to scale dynamically, support concurrent processes, and manage complex data workflows. This architecture integrates modular and distributed components to ensure seamless communication between subsystems, robust data persistence, and scalable reasoning processes.

At the entry point of the system, the External Application (1401) facilitates interaction between external data sources or queries and the internal subsystems. This component acts as a gateway, accepting inputs such as raw data, structured queries, or contextual cues, and directing them to the appropriate subsystems for processing. The communication facilitated by the External Application ensures smooth integration of external requests into the distributed architecture.

The Thought Simulation Subsystem (1402) is central to the system's reasoning capabilities. It consists of the Thought Simulation Interface and the Thought Manager, which work collaboratively to process retrieved data and simulate reasoning. The Thought Simulation Interface handles communication with the External Application and ensures that queries are routed to the appropriate memory management components. The Thought Manager integrates information retrieved from the memory system to simulate reasoning processes, generate actionable insights, or refine thoughts. This subsystem's dynamic interaction with the Memory Management Subsystem enables real-time processing and supports concurrent reasoning tasks across multiple queries.

The Memory Management Subsystem (1403) serves as the backbone of the architecture, providing robust and scalable memory operations. This subsystem includes multiple Memory Manager Interfaces, each linked to a Memory Builder and a Memory Recall Manager. The Memory Manager Interfaces facilitate communication between the Thought Simulation Subsystem and the distributed memory modules, ensuring efficient data flow. The Memory Builder organizes and constructs memory constructs from incoming data, embedding them within the Memory Model. The Memory Recall Manager retrieves stored constructs for analysis, enabling iterative and contextual reasoning. By decoupling these functions, the architecture supports parallel processing, ensuring scalability and adaptability for handling large-scale datasets.

The Distributed Memory Storage (1404) ensures long-term data persistence across multiple nodes, providing a robust foundation for memory constructs. This storage system supports scalable data management, allowing for efficient retrieval and storage of constructs, even in scenarios involving high concurrency or large datasets. The distributed nature of the storage system ensures fault tolerance and load balancing, enhancing the system's reliability and performance.

Data flows seamlessly from the External Application (1401) through the Thought Simulation Subsystem (1402) to the Memory Management Subsystem (1403), where it is either processed and stored in the Distributed Memory Storage (1404) or retrieved for further analysis. This modular design allows the system to scale dynamically, supporting concurrent operations across multiple instances of memory management and thought simulation components. For example, multiple Memory Manager Interfaces can process separate tasks simultaneously, while the Distributed Memory Storage ensures consistent access to shared constructs.

The architecture emphasizes modularity and scalability, enabling the system to handle complex relationships and large-scale data efficiently. Each subsystem operates as an independent yet interconnected module, allowing for flexible configuration and adaptation to diverse application requirements. This design supports concurrent processing of multiple queries, ensuring that the system can manage high volumes of data and maintain efficient workflows.

The described embodiment in FIG. 14 highlights the system's capability to support scalable knowledge management, dynamic thought simulation, and efficient data processing. By integrating distributed memory storage, parallel processing, and robust subsystem communication, the architecture enables applications such as automated reasoning, insight generation, and interactive systems. The modular and distributed design ensures that the system can adapt to evolving needs, making it a versatile and powerful tool for managing complex data environments and supporting advanced reasoning tasks.

### Feasibility for Real-Time Processing

FIG. 15 illustrates a practical embodiment of the invention, showcasing the performance of the Dynamic Gist-Based Memory Model (DGMM) in executing its core computational operations: memory recall (MemS), embedding generation (Embeds), and similarity computation (SimS). These operations form the foundational processes that enable advanced reasoning tasks, including surprise generation and proposition generation, which build upon the results of these core operations. The demonstrated embodiment highlights the system's ability to process subgraphs efficiently and achieve end-to-end results within sub-minute processing times for all analyzed concepts, including “AARDVARK,” “CELL,” “CARBON,” “FROG,” “CREATURE,” and “TERMITE.”

In the examples provided, subjects along with their associated timeslots were used as context cues to dynamically retrieve relevant subgraphs from the DGMM. The subgraphs were constructed by traversing nodes and relationships connected to the context cues up to a configurable number of degrees (n). The total graph size in this embodiment was approximately 64,000 nodes, reflecting a robust dataset capable of supporting complex contextual reasoning.

The MemS operation represents the time taken to retrieve subgraphs dynamically from the DGMM based on these contextual cues. This process involves traversing the graph structure while applying filters for semantic relevance, temporal metadata, and task-specific criteria. MemS consistently required the largest portion of processing time, reflecting the computational effort needed to identify and retrieve meaningful portions of the Memory Model.

The Embeds operation follows MemS, generating vector embeddings for the retrieved subgraphs using the Fast Random Projection (FASTRP) algorithm. For this demonstration, the embedding process was configured with parameters including a 512-dimensional embedding space, iteration weights of [1, 1, 0.75] to prioritize first-degree and higher-order relationships, and concurrency limited to four threads. Embeds contributed significantly to processing time but remained computationally efficient, leveraging parallelization to handle complex subgraphs within the large graph.

The SimS operation computes semantic similarity between concepts within the retrieved subgraph, utilizing a K-Nearest Neighbors (KNN) algorithm. The algorithm identified the top 10 nearest neighbors for each concept based on vector similarity, establishing relationships for similarity scores exceeding 0.1. SimS consistently exhibited the smallest time requirement among the three core operations, highlighting its efficiency in leveraging precomputed embeddings for semantic analysis.

Together, MemS, Embeds, and SimS dominate the computational workload, forming the backbone of the system's contextual reasoning capabilities. These processes are followed by advanced reasoning tasks such as surprise generation (detecting deviations in semantic relationships or embedding metrics) and proposition generation (synthesizing meaningful relationships or predictions), which rely on the outputs of MemS, Embeds, and SimS. These downstream tasks add only a few seconds to the overall processing time, ensuring that the entire workflow, from memory recall to advanced reasoning, efficiently processing within practical timeframes.

This embodiment was implemented on a 12th Gen Intel(R) Core(TM) i7-1255U laptop with 1.70 GHz processing speed, 64 GB of RAM (63.7 GB usable), and running Windows 11 Home Edition (64-bit). Neo4j was used as the graph database, leveraging its Data Science package to manage the DGMM and perform the described computations. The parameters and configurations used for MemS, Embeds, and SimS were selected to demonstrate the invention's capabilities and are not intended to limit the scope of the claims. For example, the 512-dimensional embedding space, three-degree traversal, and four-thread concurrency are illustrative and may be adjusted based on hardware, software, or application-specific requirements.

Importantly, this embodiment reflects the flexibility and scalability of the DGMM, demonstrating efficient processing under constrained hardware and software conditions. The use of 64,000 nodes showcases the DGMM's ability to handle large graph sizes, while the inclusion of context cues based on subjects and timeslots illustrates its capability to manage dynamic, context-driven subgraph retrieval. It is anticipated that deploying the system on enterprise-grade server infrastructure with enhanced computational resources and full software licensing would result in significantly faster processing times. The ability to dynamically configure parameters, such as traversal depth (n), embedding dimensionality, and similarity thresholds, underscores the adaptability of the invention to various use cases and performance requirements.

In conclusion, FIG. 15 serves as a measurement of an embodiment of the invention, highlighting the practical implementation and performance of the DGMM in real-world scenarios. The demonstrated algorithms, parameters, and configurations are for illustrative purposes, reflecting the DGMM's ability to support diverse applications while maintaining scalability and efficiency. The results underscore the invention's suitability for real-time contextual reasoning tasks, including anomaly detection, recommendation generation, and semantic analysis, without being constrained to the specific configurations presented in this embodiment.

### CONCLUSION

In conclusion, the invention introduces a groundbreaking system for contextual memory management and proposition generation, centered on the Dynamic Gist-Based Memory Model (DGMM). By leveraging a graph-based structure with nodes for concepts, elements, interactions, and time, the DGMM enables real-time, contextually driven retrieval and processing of information. This approach addresses critical limitations in traditional systems, such as redundancy, inefficiency, and lack of adaptability, while enhancing transparency, scalability, and semantic precision.

The integration of advanced features—such as gist-based storage, dynamic subgraph retrieval, and real-time proposition generation—makes this invention highly versatile, supporting applications in decision-making, automated reasoning, and knowledge representation across diverse industries. By reducing computational overhead and ensuring contextual alignment, the system delivers a robust framework for managing complex and evolving data environments.

The foregoing description highlights the key features and advantages of the invention. The following claims are intended to define the scope of the invention and its various embodiments, ensuring comprehensive protection for this innovative framework.

1. A Dynamic Gist-Based Memory Model (DGMM) for organizing, storing, and managing data in a system, comprising:
nodes representing:
concept nodes encapsulating distinct ideas or entities;
element nodes representing attributes or modifiers linked to concepts, including subject, object, action, subject modifier, object modifier, and action modifier;
interaction nodes grouping related concept nodes within a session or context;
source nodes specifying the origin of a concept and linking to corresponding concept nodes;
time nodes capturing temporal information associated with interactions and concepts and linking to the corresponding nodes;
predefined relationships between nodes, defining semantic and contextual associations, including:
fixed relationships, such as subject, object, action, subject modifier, object modifier and action modifier;
weighted relationships representing occurrence frequency or trustworthiness;
properties associated with nodes and relationships, comprising:
occurrence frequencies indicating the prevalence of relationships or concepts;
embedding vectors for graph-based computations;
trustworthiness scores reflecting the reliability of sources or data points;
unique naming and identification rules for nodes, wherein:
element nodes and time nodes have unique names to ensure distinct identification;
concept nodes, interaction nodes, and source nodes have unique identifiers, enabling distinct tracking even when overlapping or identical information exists;
a dynamic subgraph retrieval mechanism configured to:
dynamically retrieve subgraphs based on context cues derived from nodes, relationships, properties, or metadata;
traverse nodes up to a configurable number of degrees (n) and prioritize retrieval using properties including semantic relevance and temporal metadata;
a real-time adaptability mechanism to:
integrate new concepts dynamically based on evolving contextual inputs;
update and align relationships and properties in response to real-time data;
wherein the DGMM facilitates scalable, unsupervised storage, retrieval, and processing of information, enabling downstream operations such as embedding generation, similarity computation, and clustering for reasoning tasks.

2. A system utilizing the DGMM for real-time contextual reasoning, comprising:
a memory management subsystem configured to:
dynamically retrieve subgraphs from the DGMM based on context cues derived from nodes, relationships, properties, or metadata, including nodes connected up to a configurable number of degrees (n);
prioritize subgraph retrieval based selected node types;
maintain immutable persistent storage of the DGMM, ensuring that stored nodes, relationships, and properties remain unaltered during retrieval and processing;
store newly generated propositions within the DGMM, wherein:
propositions are represented as new concept nodes or relationships;
propositions are explicitly sourced by the system and linked to the reasoning processes that generated them;
an embedding subsystem configured to:
generate vector embeddings for the retrieved subgraphs using a fast graph-based embedding algorithm, including but not limited to Fast Random Projection (FASTRP);
optimize embedding performance through configurable parameters, including dimensionality and concurrency;
a similarity computation subsystem configured to:
run graph-based similarity algorithms, including K-Nearest Neighbors (KNN), on the embedded vectors to generate task-specific propositions by synthesizing relationships between nodes and identifying emergent patterns;
a clustering subsystem configured to:
analyze the embedded vectors using clustering algorithms, including Density-Based Spatial Clustering of Applications with Noise (DBSCAN), to identify surprising concepts by detecting anomalies, deviations, or unexpected groupings within the subgraph;
a reasoning engine configured to:
dynamically adjust subgraph retrieval parameters, similarity thresholds, and clustering criteria based on feedback from real-time inputs or outputs;
produce actionable insights tailored to specific tasks, including predictions, recommendations, and anomaly detection;
a thought management subsystem configured to:
dynamically adjust subgraph retrieval parameters, similarity thresholds, and clustering criteria in response to real-time inputs, outputs, or evolving contextual requirements;
refine generated propositions and surprising concept detections based on iterative reasoning and adaptive feedback loops;
produce actionable insights tailored to specific tasks, including predictions, recommendations, semantic alignments, or anomaly detection;
associate each proposition with metadata, including the reasoning context, processing parameters, and the timestamp of generation;
an interface configured to:
accept inputs from external applications or entities, including semantic queries, temporal parameters, or other context cues;
provide outputs generated by the thought management subsystem, such as task-specific propositions, surprising concept detections, or similarity relationships;
wherein the system operates in a fully unsupervised manner, leveraging the DGMM structure and dynamically generated embeddings, and completes embedding, similarity computation, and clustering within practical timeframes appropriate for contextual reasoning tasks, enabling real-time contextual reasoning, proposition generation, and surprising concept identification.

3. The DGMM of claim 1, wherein subgraph retrieval dynamically adjusts the configurable number of degrees (n) based on task-specific requirements or real-time feedback.

4. The DGMM of claim 1, wherein subgraph retrieval prioritizes context cues derived from temporal parameters, element identities, source metadata, or interaction identifiers.

5. (canceled)

6. The DGMM of claim 1, wherein time nodes and their relationships enable chronological alignment of concepts and interactions for time-sensitive reasoning.

7. (canceled)

8. (canceled)

9. The system of claim 2, wherein the memory and thought management subsystems operate in a fully unsupervised manner, dynamically retrieving, processing, and analyzing subgraphs without requiring pretraining or labeled datasets.

10. The system of claim 2, wherein the embedding subsystem generates vector embeddings directly from retrieved subgraphs, using only graph-structured data from the DGMM, without relying on external training models.

11. The system of claim 2, wherein the similarity computation and clustering subsystems perform reasoning tasks solely based on the relationships, properties, and context cues within the DGMM, enabling adaptability to new data without external supervision.

12. The system of claim 2, wherein system-generated outputs, including propositions and surprising concepts, are iteratively refined through real-time feedback from the DGMM structure, without human-labeled input.

13. (canceled)

14. (canceled)

15. (canceled)

16. The system of claim 2, wherein clustering results dynamically update context cues for subsequent subgraph retrievals, enabling adaptive reasoning.

17. The system of claim 2, wherein proposition generation outputs include predictions, recommendations, semantic alignments, or trend analyses based on subgraph similarity computations.

18. The system of claim 2, wherein the thought management subsystem dynamically adjusts retrieval parameters, similarity thresholds, and clustering criteria in response to real-time inputs or evolving contextual requirements.

19. The system of claim 2, wherein the interface supports bi-directional communication, enabling external applications to refine context cues, adjust parameters, and retrieve system-generated outputs in real time.

20. The system of claim 2, further comprising an interface configured to facilitate communication between the memory management subsystem and the thought management subsystem, wherein the interface:
accepts context cues, including temporal parameters, semantic queries, and interaction identifiers, derived from memory management operations;
transmits task-specific subgraph outputs, including embeddings and retrieved relationships, to the thought management subsystem for further processing.

21. (canceled)

22. (canceled)

23. (canceled)

24. (canceled)

25. (canceled)

26. (canceled)

27. (canceled)

28. The system of claim 2, wherein the thought management subsystem supports multi-tasking by concurrently processing multiple subgraphs for independent reasoning tasks.

29. (canceled)

30. (canceled)

31. The system of claim 2, wherein the interface provides outputs generated by the thought management subsystem, including:
propositions derived from similarity relationships;
detected surprising concepts;
context-specific recommendations or predictions.

32. The system of claim 2, wherein the interface integrates with external systems via APIs, facilitating seamless communication with natural language processing frameworks or semantic analysis tools.

33. The system of claim 2, wherein the interface enables distributed processing by coordinating inputs and outputs across multiple instances of the DGMM in a networked environment.

34. The system of claim 2, wherein the system-generated propositions are stored with metadata, including:
the originating context cues;
temporal information indicating the time and sequence of proposition generation.

35. The system of claim 2, wherein system-generated propositions are linked to the DGMM as:
new concept nodes with properties reflecting the reasoning task that produced them;
source node wherein the identifier is associated with the thought management system;
relationships between existing nodes, indicating newly identified patterns or insights.

36. (canceled)

37. (canceled)
